(19) United States
(12) Patent Application Publication
(10) Pub. No.: US 2015/0346998 A1
(43) Pub. Date: Dec. 3, 2015

(54) RAPID TEXT CURSOR PLACEMENT USING FINGER ORIENTATION

(71) Applicant: QUALCOMM Incorporated, San Diego, CA (US)

(72) Inventors: Ian CLARKSON, Toronto (CA); Francis Bernard MACDOUGALL, Milton (CA)

(21) Appl. No.: 14/723,125

(22) Filed: May 27, 2015

Related U.S. Application Data
(60) Provisional application No. 62/005,771, filed on May 30, 2014.

(51) Int. Cl. G06F 3/0488; G06F 3/0484; G06F 3/041

(52) U.S. Cl. CPC G06F 3/04883; G06F 3/0416; G06F 3/04842

(57) ABSTRACT

Aspects of the disclosed subject matter are related to a method for utilizing touch object orientation with a touch user interface. First, a first location within a text body on the touch interface is determined. Next, a change in an orientation of a touch object is determined while the touch object remains in contact with the touch device. Thereafter, a second location within the text body on the touch user interface different from the first location is determined based at least in part on the first location and the change in the orientation of the touch object.

### RELATED APPLICATIONS

This application claims priority to provisional patent application Ser. No. 62/005,771, entitled Rapid Option Selection Using Finger Angle, filed May 30, 2014, which is incorporated in its entirely herein by reference.

### FIELD

The subject matter disclosed herein relates to electronic devices, and more particularly to methods, apparatuses, and systems for use in and/or with touch input devices.

### BACKGROUNDS

Certain operations may be inefficient or cumbersome with a conventional touch user interface. One example is to pinpoint a location within a text body and move the text cursor to the location. Due to the relatively large size of the fingertip compared to the precision requirement and/or the limited resolution of the touch input device, selecting locations with high precision on a touch user interface with conventional touch inputs may be cumbersome and difficult.

### SUMMARY

Aspects of the disclosed subject matter are related to a method for utilizing touch object orientation with a touch user interface, comprising: determining a first location within a text body on the touch user interface; determining a change in an orientation of a touch object while the touch object remains in contact with the touch device; and determining a second location within the text body on the touch user interface different from the first location based at least in part on the first location and the change in the orientation of the touch object.

### BRIEF DESCRIPTION OF THE DRAWINGS

FIG. 1 illustrates an embodiment of a device adapted for touch applications.

FIG. 2A illustrates an example method for determining a rotation of a finger on a touch input device.

FIG. 2B illustrates an example method for determining a change in the tilt of a finger on a touch input device.

FIG. 3 illustrates an example method for moving a text cursor to a desired location within a pre-existing text body with rotations and/or changes in the tilt of a finger on a touch input device.

FIG. 4 is a flowchart illustrating an example method for utilizing touch object orientation with a touch user interface.

### DETAILED DESCRIPTION

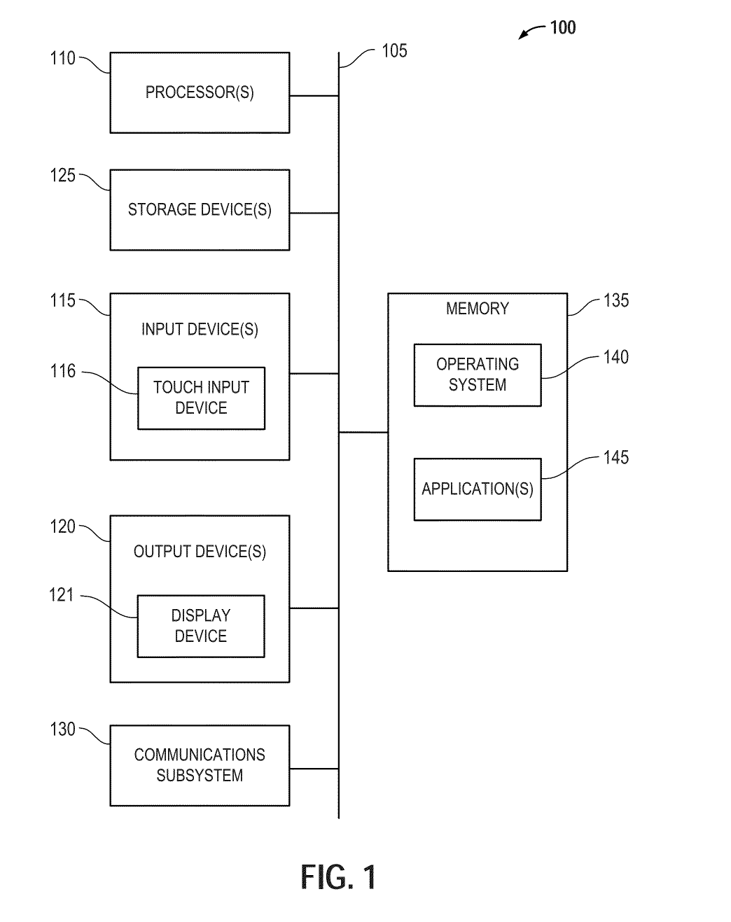

An example device 100 adapted for touch applications is illustrated in FIG. 1. The device 100 is shown comprising hardware elements that can be electrically coupled via a bus 105 (or may otherwise be in communication, as appropriate). The hardware elements may include one or more processors 110, including without limitation one or more general-purpose processors and/or one or more special-purpose processors (such as digital signal processing chips, graphics acceleration processors, and/or the like); one or more input devices 115, which include at least a touch input device 116, and can further include without limitation a mouse, a keyboard, and/or the like; and one or more output devices 120, which include at least a display device 121, and can further include without limitation a speaker, a printer, and/or the like. The touch input device 116 and the display device 121 may be combined into a touchscreen.

The device 100 may further include (and/or be in communication with) one or more non-transitory storage devices 125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The device might also include a communication subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein. In many embodiments, the device 100 will further comprise a working memory 135, which can include a RAM or ROM device, as described above.

The device 100 also can comprise software elements, shown as being currently located within the working memory 135, including an operating system 140, device drivers, executable libraries, and/or other code, such as one or more application programs 145, which may comprise or may be designed to implement methods, and/or configure systems, provided by other embodiments, as described herein. Merely by way of example, one or more procedures described with respect to the method(s) discussed below might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 125 described above. In some cases, the storage medium might be incorporated within a device, such as the device 100. In other embodiments, the storage medium might be separate from a device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computerized device 100 and/or might take the form of source and/or installable code, which, upon compilation and/or installation on the device 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Embodiments of the disclosed subject matter utilize rotations and/or changes in the tilt of a touch object to facilitate location selections within a text body on a touch user interface with greater precision than is possible with conventional touch inputs. Embodiments of the disclosed subject matter may be described hereinafter in relation to a user's finger as the touch object, but it should be appreciated that the embodiments may be adapted for other touch objects, such as a stylus, where appropriate, and the disclosed subject matter is not limited by the touch object.

Terms “rotation” and “tilt” are used in the description herein of embodiments of the disclosed subject matter. Herein, the term “rotation” is used to describe a change in the orientation of the touch object while the touch object remains in contact with the touch surface of the touch input device 116 without a change of the angle between the touch object and the touch surface of the touch input device 116. The shape and size of the touch area generally do not change when the touch object is rotated. Moreover, the term “tilt” is used to describe the angle between the touch object and the touch surface of the touch input device 116, and a change in the tilt of a touch object means a change of the angle between the touch object and the touch surface of the touch input device 116 while the touch object remains in contact with the touch input device 116. Some complex movements of the touch object may be combinations of rotations and changes in the tilt.

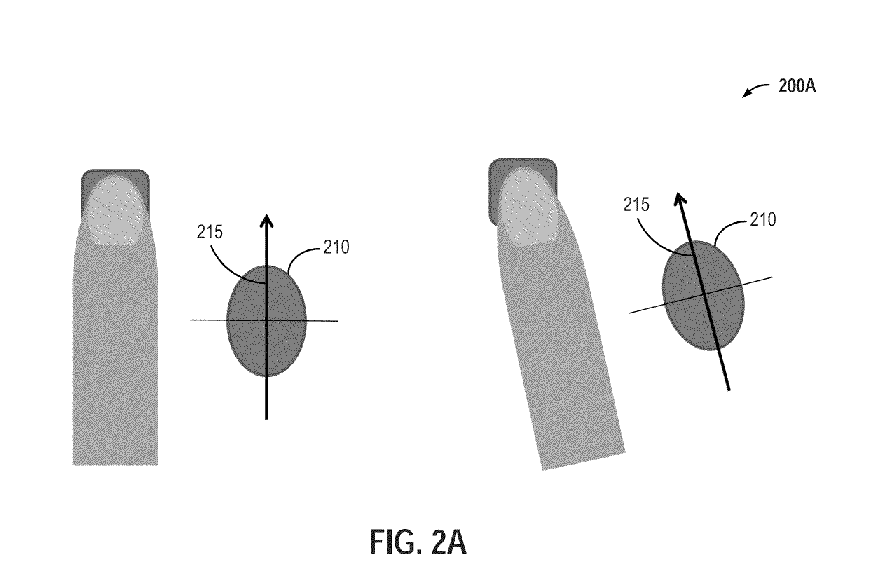

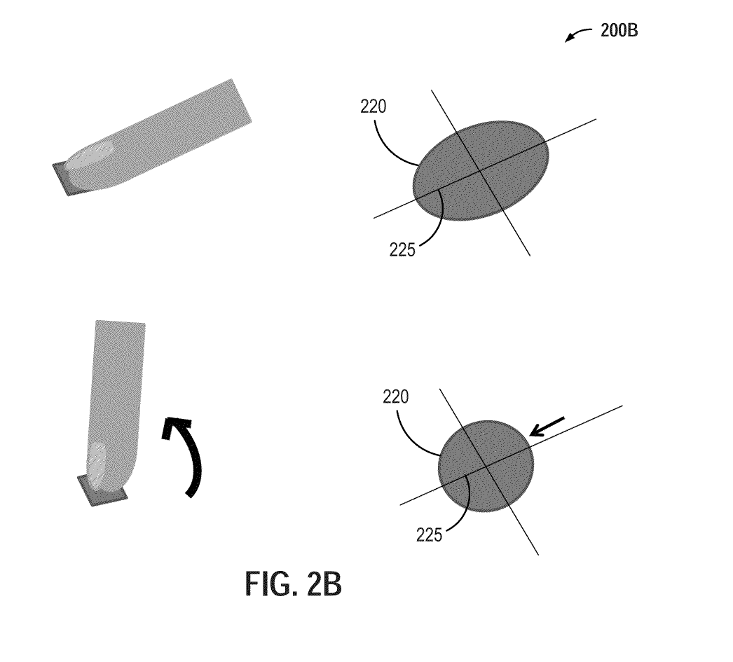

Referring to FIGS. 2A and 2B, example methods 200A and 200B for determining a rotation and/or a change in the tilt of the touch object are shown. FIG. 2A illustrates an example method 200A for determining a rotation of a finger on a touch input device 116, and FIG. 2B illustrates an example method 200B for determining a change in the tilt of a finger on a touch input device 116. It should be appreciated that any of a number of ways for determining the rotation and/or the change in the tilt of the touch object may be used, and the method for making such determinations does not limit the disclosed subject matter. As can be seen in FIG. 2A, an illustration of an example method 200A for determining a rotation of a finger on a touch input device 116, the rotation of the finger may be determined by measuring a rotation of the major axis 215 of the approximately elliptical touch area 210. Of course, in some other embodiments, it may be the minor axis that is measured to determine a rotation of a finger in contact with the touch input device 116. It should be appreciated that although the major axis 215 is shown in FIG. 2A as corresponding to the longitudinal direction of the finger, either the major axis or the minor axis of the touch area 210 may correspond to the longitudinal direction of the finger. Moreover, as can be seen in FIG. 2B, an illustration of an example method 200B for determining a change in the tilt of a finger on a touch input device 116, the change in the tilt of the finger may be determined by measuring a change in the shape of the touch area 220. As the angle between the finger and the touch surface of the touch input device 116 increases, the major axis 225 of the elliptical touch area 220 may shorten, and the elliptical touch area 220 may eventually devolve into a circular shape as the angle between the finger and the touch surface of the touch input device 116 approaches a right angle.

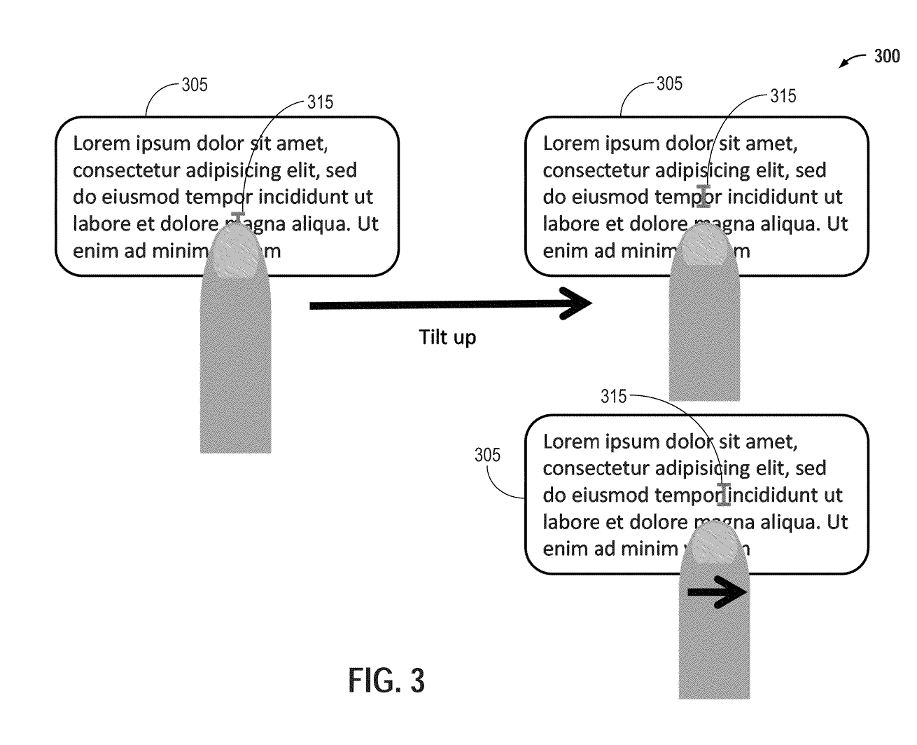

Referring to FIG. 3, an example method 300 for moving a text cursor to a desired location within a pre-existing text body with rotations and/or changes in the tilt of a finger on a touch input device 116 is shown. The user may first place the text cursor 315 at an initial location within the text body 305 by touching the initial location on the touch input device 116. Of course, this operation may be omitted if a text cursor is already present within the text body and the user merely wishes to change its location. In this scenario, the user may simply place the finger where the existent text cursor is. Then, while keeping the finger in touch with the touch input device 116, the user may move the text cursor 315 to the desired location with rotations and changes in the tilt of the finger. A rotation of the finger may cause the text cursor 315 to move horizontally within the same line of the text, while a change in the tilt of the finger may cause the text cursor 315 to move vertically between the lines. For example, the user may move the text cursor 315 rightward within the same line of text by rotating the finger clockwise, and vice versa, and the use may move the text cursor 315 to the line directly above the line where the text cursor 315 is currently located by increasing the angle between the finger and the touch surface of the touch input device 116, and vice versa.

In another embodiment, the user may perform the rotation and/or change in the tilt of the finger operations within a predetermined area of the touch user interface. The user may place the text cursor at an initial location within a text body by a simple touch at the location. Alternatively, a text cursor may already be present and its location may be considered as the initial location. In yet another embodiment, the initial location of the text cursor may be supplied by the system, either randomly or at a predetermined location, after it has been detected that the user has started performing rotation and/or change in the tilt of the finger operations within the predetermined area of the touch user interface. The user may then move the text cursor to a desired location within the text body by performing the rotation and/or change in the tilt of the finger operations while keeping the finger in contact with the touch device within the predetermined area of the touch user interface. The text cursor may move in the same way in response to the user's operations as described above: a rotation of the finger may cause the text cursor to move horizontally within the same line of the text, while a change in the tilt of the finger may cause the text cursor to move vertically between the lines.

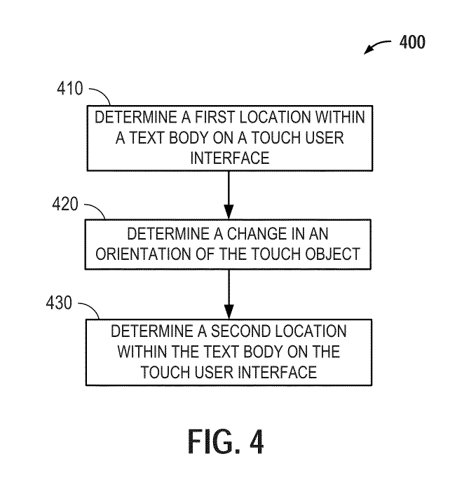

Referring to FIG. 4, a flowchart illustrating an example method 400 for utilizing touch object orientation with a touch user interface is shown. The touch object may be a finger, or a stylus, etc. At block 410, a first location within a text body on a touch user interface may be determined. The first location may be an initial location of a text cursor. Various methods for determining or selecting an initial location of the text cursor have been described in detail hereinbefore. At block 420, a change in an orientation of the touch object while the touch object remains in contact with the touch device may be determined. The change in the orientation may include a rotation of the touch object or a change in the tilt of the touch object. At block 430, a second location within the text body on the touch user interface different from the first location may be determined based at least in part on the first location and the change in the orientation of the touch object. The second location may be the location within the text body where the user desires the text cursor to be. Thereafter, the text cursor may be moved to the second location.

Embodiments of the disclosure may be related to a touch device apparatus comprising: a memory; and a processor coupled to the memory, the processor to: determine a first location within a text body on a touch user interface, determine a change in an orientation of a touch object while the touch object remains in contact with the touch device, and determine a second location within the text body on the touch user interface different from the first location.

Therefore, embodiments of the disclosed subject matter described herein make use of rotations and/or changes in the tilt of the touch object to enable a user to pinpoint locations within a text body on the touch user interface with greater precision than would be possible with conventional touch inputs.

It should be appreciated that aspects of the disclosed subject matter previously described may be implemented in conjunction with the execution of instructions (e.g., applications) by processor 110 of device 100, as previously described. Particularly, circuitry of the device, including but not limited to processor, may operate under the control of an application, program, routine, or the execution of instructions to execute methods or processes in accordance with embodiments of the disclosed subject matter (e.g., the processes of FIG. 4). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

Methods described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

Example methods, apparatuses, or articles of manufacture presented herein may be implemented, in whole or in part, for use in or with mobile communication devices. As used herein, “mobile device,” “mobile communication device,” “hand-held device,” “tablets,” etc., or the plural form of such terms may be used interchangeably and may refer to any kind of special purpose computing platform or device that may communicate through wireless transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, or the like. It should be appreciated, however, that these are merely illustrative examples relating to mobile devices that may be utilized to facilitate or support one or more processes or operations described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeroes). As such, in a particular implementation, such a change of state of the portion of the storage media to store a signal representative of data and/or information constitutes a transformation of storage media to a different state or thing.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

Reference throughout this specification to “one example”, “an example”, “certain examples”, or “example implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method for utilizing touch object orientation with a touch user interface on a touch device, comprising:
determining a first location within a text body on the touch user interface;
determining a change in an orientation of a touch object while the touch object remains in contact with the touch device; and
determining a second location within the text body on the touch user interface different from the first location based at least in part on the first location and the change in the orientation of the touch object.

2. The method of claim 1, wherein the change in the orientation of the touch object comprises at least a rotation of the touch object or a change in a tilt of the touch object.

3. The method of claim 2, wherein the rotation of the touch object is determined by determining a rotation of a major axis of an ellipse representative of a touch area.

4. The method of claim 2, wherein the change in the tilt of the touch object is determined by determining a change in a shape of an ellipse representative of a touch area.

5. The method of claim 2, wherein the rotation of the touch object corresponds to a horizontal location change within the text body, and the change in the tilt of the touch object corresponds to a vertical location change within the text body.

6. The method of claim 1, wherein the first location is selected by a user.

7. The method of claim 1, wherein the touch object remains in contact with the touch device within a predetermined area of the touch user interface.

8. The method of claim 1, wherein the touch object is a finger or a stylus.

9. A touch device apparatus, comprising:
means for determining a first location within a text body on a touch user interface;
means for determining a change in an orientation of a touch object while the touch object remains in contact with the touch device; and
means for determining a second location within the text body on the touch user interface different from the first location based at least in part on the first location and the change in the orientation of the touch object.

10. The touch device apparatus of claim 9, wherein the change in the orientation of the touch object comprises at least a rotation of the touch object or a change in a tilt of the touch object.

11. The touch device apparatus of claim 10, wherein the rotation of the touch object is determined by determining a rotation of a major axis of an ellipse representative of a touch area.

12. The touch device apparatus of claim 10, wherein the change in the tilt of the touch object is determined by determining a change in a shape of an ellipse representative of a touch area.

13. The touch device apparatus of claim 10, wherein the rotation of the touch object corresponds to a horizontal location change within the text body, and the change in the tilt of the touch object corresponds to a vertical location change within the text body.

14. The touch device apparatus of claim 9, wherein the first location is selected by a user.

15. The touch device apparatus of claim 9, wherein the touch object remains in contact with the touch device within a predetermined area of the touch user interface.

16. The touch device apparatus of claim 9, wherein the touch object is a finger or a stylus.

17. A touch device apparatus, comprising:
a memory; and
a processor coupled to the memory, the processor to:
determine a first location within a text body on a touch user interface,
determine a change in an orientation of a touch object while the touch object remains in contact with the touch device, and
determine a second location within the text body on the touch user interface different from the first location based at least in part on the first location and the change in the orientation of the touch object.

18. The touch device apparatus of claim 17, wherein the change in the orientation of the touch object comprises at least a rotation of the touch object or a change in a tilt of the touch object.

19. The touch device apparatus of claim 18, wherein the rotation of the touch object is determined by determining a rotation of a major axis of an ellipse representative of a touch area.

20. The touch device apparatus of claim 18, wherein the change in the tilt of the touch object is determined by determining a change in a shape of an ellipse representative of a touch area.

21. The touch device apparatus of claim 17, wherein the rotation of the touch object corresponds to a horizontal location change within the text body, and the change in the tilt of the touch object corresponds to a vertical location change within the text body.

22. The touch device apparatus of claim 17, wherein the first location is selected by a user.

23. The touch device apparatus of claim 17, wherein the touch object remains in contact with the touch device within a predetermined area of the touch user interface.

24. A non-transitory computer-readable medium comprising code which, when executed by a processor of a touch device, causes the processor to perform a method comprising:
determining a first location within a text body on a touch user interface;
determining a change in an orientation of a touch object while the touch object remains in contact with the touch device; and
determining a second location within the text body on the touch user interface different from the first location based at least in part on the first location and the change in the orientation of the touch object.

25. The non-transitory computer-readable medium of claim 24, wherein the change in the orientation of the touch object comprises at least a rotation of the touch object or a change in a tilt of the touch object.

26. The non-transitory computer-readable medium of claim 25, wherein the rotation of the touch object is determined by determining a rotation of a major axis of an ellipse representative of a touch area.

27. The non-transitory computer-readable medium of claim 25, wherein the change in the tilt of the touch object is determined by determining a change in a shape of an ellipse representative of a touch area.

28. The non-transitory computer-readable medium of claim 25, wherein the rotation of the touch object corresponds to a horizontal location change within the text body, and the change in the tilt of the touch object corresponds to a vertical location change within the text body.

29. The non-transitory computer-readable medium of claim 24, wherein the first location is selected by a user.

30. The non-transitory computer-readable medium of claim 24, wherein the touch object remains in contact with the touch device within a predetermined area of the touch user interface.
